(19) United States
(12) Patent Application Publication
(10) Pub. No.: US 2006/0167959 A1
(43) Pub. Date: Jul. 27, 2006

(54) Storing programs on disk for multiple-user retrieval

(75) Inventor: Serverius Petrus Paulus Pronk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/546,068

(22) PCT Filed: Feb. 12, 2004
(86) PCT No.: PCT/IB04/50106

§ 371 Date: Aug. 18, 2005

(30) Foreign Application Priority Data
Feb. 25, 2003 (EP) 03100455.9

(51) Int. Cl. G06F 12/00; G06F 17/30

(52) U.S. Cl. 707/205

(57) ABSTRACT

Multiple VBR video programs are stored on MZR disk so as to optimize retrieval of programs in a VOD setting. The programs are stored on the disk from the outer to the inner edge in a sequence of substantially monotonically non-increasing weight-over-size ratio. The weight of a program depends on the program's bit rate, the program's duration and the program's popularity.

### FIELD OF THE INVENTION

The invention relates to a method of storing data files such as audio/video programs on a disk, e.g., a magnetic disk. The invention is particularly, but not exclusively, relevant to service providers of a video-on-demand (VOD) service.

### BACKGROUND ART

A magnetic disk, referred to as hard-disk drive (HDD), is an appropriate mass storage device for use in VOD servers to store and efficiently retrieve multiple video programs simultaneously by a number of clients. The storage capacity of a single disk suffices to store dozens of digitized, high-quality MPEG-encoded variable-bit-rate (VBR) programs, and the rate at which data can be read from disk enables dozens of users to watch these programs independently at the same time.

When a user decides to watch a program, a play-out process is started that repeatedly fetches a data block of this program from disk, and stores it in a solid-state memory buffer. Both the speed at which this should happen and the size of the data blocks depend on, amongst other things, the program itself as well as on specific settings of the server. The speed should be sustainable to allow uninterrupted play-out for the duration of the program by means of preventing the buffer from under- and/or overflowing. The buffer is emptied at a corresponding rate and its content is sent onward to the user, e.g., via an access network and in-home network. This rate is typically in the order of 5-7 Mbit/s. Besides linear viewing, pausing, and jumping to another scene or part of the movie, trick modes are supported, such as reverse viewing, slow motion in either direction and fast reverse/forward at several speeds. Depending on the popularity of a specific program, more users may want to see the same program at more or less the same time. This results in a corresponding number of independent play-out processes.

Simultaneously sustaining a number of play-out processes requires a disk-scheduling algorithm to guarantee the quality of service required by each of the processes. For an overview of disk scheduling algorithms see, e.g., “Comparing disk scheduling algorithms for VBR data streams”, Jan Korst et al., Computer Communications 21 (1998) pp. 1328-1343.

The physical properties of a disk give rise to a varying maximum transfer rate at which data can be read from or written to disk, depending on the radial location of the read head or write head relative to the disk's surface. Data stored near the inner edge of the disk surface is read at a lower rate than data stored near the outer edge as the disk revolves at a constant angular speed. Typical values are 200 Mbit/s near the inner edge to 400 Mbit's near the outer edge for current state-of-the-art magnetic disks.

Disks that are currently commercially available typically employ multiple zones. A zone is a set of contiguous tracks and the transfer rate is kept constant per zone. These multi-zone recording (MZR) disks aim to approximate the ideal situation of a constant-density disk where the transfer rate decreases linearly in anti-radial direction, i.e., from the outer to the inner edge of the disk surface. For more background on MZR see, e.g., C. Ruemmler and J. Wilkes, “An introduction to disk drive modeling”, 1994, IEEE Computer, Vol. 27, No. 3, pp. 17-29.

Often, the so-called minimum sustainable transfer rate (mSTR), is used to perform admission control with deterministic quality guarantees for new play-out processes. The mSTR corresponds to reading a large data block near the inner edge of the disk. Reading at the mSTR can at all times be guaranteed. As an example, a disk with an mSTR of 200 Mbit/s can simultaneously sustain 200/6=33 play-out processes of 6 Mbit/s each. For reference, the maximum sustainable transfer rate (MSTR) is attained when reading a large data block near the outer edge of the disk.

To improve the efficiency of reading data from disk, a storage strategy, known as “track pairing” (TP), splits each data block into two sub-blocks. One sub-block is stored closer to the outer edge of the disk, whereas the other one is stored closer to the inner edge. The size of the sub-blocks and their location on disk are such that they require an equal reading time and reading two pairing sub-blocks results in a constant and significantly larger transfer rate than the mSTR. The rate of reading these paired sub-blocks, referred to as the average sustainable transfer rate (ASTR), can also be used to provide deterministic quality guarantees. For more background on TP, see, e.g., Y. Birk, “Track pairing: a novel data layout for VOD servers with multi-zone recording disks”, 1995, Proc. IEEE International Conference on Multimedia Computing and Systems, pp. 248-255.

In “Placement of Data in Multi-Zone Disk Drives”, S. Ghandeharizadeh et al., Proceedings 2^{nd} International Baltic Workshop on Databases and Information Systems, BalticDB'96, Tallin, Estonia, 1996, pp. 1-14, techniques are described to improve the performance of MZR disks by controlling the (off-line) placement of data across the zones. More specifically, Ghandeharizadeh et al., propose to rank the files according to their frequency of access, i.e., their popularity, from high to low, and to lay out the sequence of the files contiguously starting with the outermost (i.e., fastest) zone and progressively proceeding towards the innermost zone. This ordering is said to minimize the average transfer time per file.

### SUMMARY OF THE INVENTION

The inventor considers the problem of how to store a plurality of files or programs on a disk such that disk resource usage is optimized. To this end, each program is considered to be characterized by its bit rate, duration, size, and popularity.

The bit rate of a program is indicative of the sustainable play-out speed and is typically based on the maximum average frame size, computed over any number of successive frames, the number being relatively small. It may alternatively be based on bit-rate smoothing algorithms. Bit-rate smoothing algorithms are used to achieve efficient transmission of VBR data across a network. As such, the bit rate of a program is generally much smaller than its peak rate, the lafter being determined by a maximum-size frame. The bit rate as such is also generally larger than its average rate. The bit rate value can be used to provide deterministic quality guarantees. The duration of a program typically expresses the linear play-out time of the entire program, but could alternatively describe the average play-out time of an associated play-out process in case, e.g., trick modes such as jumping and replaying are performed often. The popularity is represented by the fraction of the total number of client requests per unit time for this program. The size gives the number of bits of the file in which the program is stored on the disk. Note that for a variable-bit-rate (VBR) program it generally holds that its bit rate is larger than the ratio of its size over its duration. When a program has been stored on disk, a transfer rate R can be associated with this program that expresses the minimum rate at which data from this program is retrieved from disk. Transfer rate R corresponds with the transfer rate corresponding with reading data of this program that is stored closer to the inner edge of the disk than any other data of this same program. Note that, when a plurality of programs are to be stored on disk, the transfer rate R of a specific program depends on the overall allocation of storage space to the individual programs.

Storing on, e.g., a magnetic disk, real-time data files such as video programs, can be optimized for disk resource usage, e.g., its transfer rate. The transfer rate determines the efficiency of playing out these programs in a multiple-user VOD setting. A cost function can be defined that for which then an optimal solution is to be found that minimizes the cost. For MZR disks, the off-line problem of optimally storing a number of programs is an NP-hard (non-deterministic polynomial) problem. Accordingly, due to the complexity of the problem, there is a need for a pragmatic solution that gives an optimal or near-optimal storage arrangement.

The inventor proposes a method of storing multiple data files on a disk as follows in order to obtain an optimal or near-optimal solution to the off-line problem. Each file is assigned a weight, whose value depends on the value of the file's bit rate, the value of its duration and the value of its popularity and possibly on more aspects. The weight represents the load of this specific file to the disk system in terms of resource usage. For example, the weight of a specific file can be taken as depending on the product of its bit rate, its duration and its popularity. Simulations strongly suggest that an optimal or near-optimal storage is obtained when the files are arranged from the outer to the inner edge of the disk in the order of non-increasing value of the ratio of the file's weight over the file's size. More specifically, an embodiment of the invention relates to a method of storing multiple data files on a disk in an off-line setting. Each respective one of the data files is characterized by a respective value of a size of the respective file; and by a respective value of a weight. The weight depends on a sustainable play-out speed of the respective file, the duration of a play-out process of the respective file and the popularity of the respective file. According to the method, the respective data files are accommodated at respective locations on the disk with respective radial disk coordinates. In this embodiment, the respective files form a substantially non-increasing sequence of respective values of the ratio of the respective value of the weight over the respective value of the size in a direction of decreasing respective radial disk coordinates. In a further embodiment of the invention, the data files comprise video content. Preferably, the method is being used in a VOD service. Preferably, the disk comprises an MZR disk. Preferably, at least one of the data files comprises VBR-encoded content. The term “substantially” as used above indicate that slight deviations of the monotonically non-increasing series of the ratio weight-over-size may provide an acceptable alternative or an even better solution. Further below is described an additional optimization process. Note that the number of possible permutations of a set of the files increases more than exponentially with each next file added. Accordingly, an extremely small subset of the permutations of, say, even a dozen files corresponds to a near-optimum or optimum arrangement in the invention. A characteristic of this arrangement is that all, or substantially all, files are stored in a monotonically non-increasing series of the weight-over-size ratio in the direction of decreasing radial disk coordinates. An arrangement not showing this tendency will, for practical purposes, not be an optimum or near-optimum.

The invention also relates to a storage system with a disk that stores multiple data files. Each respective one of the data files is characterized by a respective value of a size of the respective file; and by a respective value of a weight. The weight depends on a sustainable play-out speed of the respective file, the duration of a play-out process of the respective file and the popularity of the respective file. The respective data files are stored at respective locations on the disk with respective radial disk coordinates. The respective files form a substantially monotonically non-increasing sequence of respective values of the ratio of the respective value of the weight over the respective value of the size in a direction of decreasing respective radial disk coordinates. Disks written in this manner are optimized for operational use with regard to resource usage.

A further embodiment of the invention relates to a method of storing multiple files on an MZR disk in an off-line setting. Each respective one of the files has a respective size and a respective weight. The weight depends on a sustainable play-out speed of the respective file, a duration of a play-out process of the respective file and on a popularity of the respective file. Each respective file has a respective value of the ratio weight-over-size. The disk comprises a plurality of respective zones. With each respective zone is associated a respective value of a transfer rate so that the respective values of the transfer rate form a monotonically decreasing series in a direction of decreasing radial disk coordinates. The method comprises the step of allocating the files to the zones in the following manner. Substantially each specific one of the files that is allocated to a particular one of the zones has a weight-over-size ratio not lower than a further weight-over-size ratio of substantially any further file allocated to a further zone, wherein the value of the transfer rate of the further zone is lower than the value of the transfer rate of the particular zone. This embodiment takes into account that a permutation of the ordering of the files stored within a zone of an MZR disk does not affect the value of the cost function.

The term “file” as used in this text may refer to a part of a larger file or program. Namely, for practical purposes, data files are often stored on disk in relatively large chunks of fixed size. For MZR disks, the location of all chunks completely contained within a zone can be arbitrarily permutated without compromising optimum or near-optimum resource usage according to the invention. The weight-over-size ratio of the larger file or program is a control parameter that preferably carries over to a smaller part to control the storage thereof according to the invention. Alternatively, as some parts of a program may be more popular than other parts of the same program in, e.g., a play-out process that allows trick-play modes, the more popular parts may be given a higher weight value than other parts to allow for a finer granularity in the storage. If the parts are all of the same size, this means that the ratio of weight-over-size of parts of the same file may differ from one another.

An embodiment of a system in the invention has multiple files stored on an MZR disk. Each respective one of the files has a respective size and a respective weight that depends on a sustainable play-out speed of the respective file, a duration of a play-out process of the respective file and on a popularity of the respective file. Each respective file has a respective value of the ratio weight-over-size. The disk comprises a plurality of respective zones. With each respective zone is associated a respective value of a transfer rate so that the respective values of the transfer rate form a monotonically decreasing series in a direction of decreasing radial disk coordinates. The files are allocated to the zones so that substantially each specific one of the files allocated to a particular one of the zones has a weight-over-size ratio not lower than a further weight-over-size ratio of substantially any further file allocated to a further zone, the value of the transfer rate of the further zone being lower than the value of the transfer rate of the particular zone. Again, this embodiment takes into account that a permutation of the ordering of the files or chunks thereof stored within a zone of an MZR disk does not affect the value of the cost function.

The above scenarios relate to the off-line problem: given a set of files, how are these to be put on disk so as to minimize resource usage in operational use. The inventor now applies the findings of the off-line scenario to the on-line case. In an on-line setting, new files must be stored and old ones have to be deleted on the fly.

In order to solve the on-line problem, the inventor proposes to consider classes instead of individual files or programs. Each respective one of the classes is assigned a respective class size and a respective class ratio value. The sum of the class sizes makes up the available or required disk space. The class ratio value is further explained below. It is an entity that enables comparison of weight-over-size ratios of the files to be accommodated. Class ratio values and class sizes are determined based on, e.g., user histories and user profiles in the case of a VOD context. The classes themselves are then arranged according to a monotonically non-increasing series of class ratio values in the direction from outer edge to inner edge of the disk. Once the disk locations of the classes have been defined, a new file or program is stored on the disk in the specific class whose ratio value best matches the weight-over size value of the file itself. The stored file gets its own transfer rate depending on its location on the disk. If there is not enough room in that specific class to accommodate the new file, one or more previously stored files are deleted. A suitable class management algorithm, e.g., a cache replacement algorithm such as least-frequently-used (LFU) or least-recently-used (LRU), is then to identify the files to be deleted.

The class ratio introduced above is an entity that enables to segment the available disk space in preparation of storing the files in an on-line setting. The number of classes, their ratio values and sizes are determined on the basis of, e.g., history and user profiles. For example, sample files are clustered based on their individual weight-over-size ratio values according to a clustering algorithm. Clustering algorithms partition a collection of elements into a number of subgroups. The elements within a subgroup have a certain degree of similarity. One category of clustering algorithms is known as hierarchical methods. These algorithms partition the input data into the desired number of classes in two or more steps. A series of successive accumulations of data are performed until the final number of clusters is obtained. Another category is known as non-hierarchical algorithms. These assume a fixed number of clusters from the start. Elements are allocated among the clusters so that a particular clustering criterion is optimized. A possible criterion is minimizing the variability within each cluster. Each cluster has the size of the associated sample files combined. Each cluster is assigned a cluster ratio value that is, e.g., the average of the weight-over-size ratio values of its sample files, possibly weighted to take into account the variation among the weight-over-size ratio values of the individual files, or the size of the class, etc.

More generally, the invention also relates to a method of enabling to store a data file on a disk in an on-line setting. The data file is characterized by a value of the size of the file; and by a value of the weight that depends on a sustainable play-out speed of the file, the (expected) duration of a play-out process of the file and on the popularity of the file. The disk is organized in a plurality of respective segments characterized by a respective radial disk coordinate. Each of the respective segments is assigned a respective value of a parameter so that the respective values form a monotonic series (i.e., a monotonically non-increasing or monotonically non-decreasing series) in a direction of decreasing radial disk coordinates. The method further comprises enabling to store the data file in a specific one of the segments whose value of the parameter best corresponds with a ratio of the value of the weight of the file over the value of the size of the file. A segment thus corresponds with a class as mentioned above. An example of the parameter that identifies a segment is described above, namely the class ratio that is directly comparable to the weight-over-size ratio of a file. Another example is assigning numbers to the segments that represent their order in a monotonically increasing or decreasing series of their respective radial disk coordinates. A new file is then allocated to a specific segment based on a look-up-table that maps the file's weight-over-size ratio, or a range of such ratios, on a number. The look-up table is prepared based on, e.g., history or profiling, and can be considered to represent in a condensed form the mapping of the file's weight-over-size ratio on the class ratio. Accordingly, an embodiment of the invention relates to a pre-segmented disk in combination with guidance (e.g., a data processor, a manual, a look-up table fixed or user-programmable or a service) about which segment is to be used to store what file.

For clarity, the approach by Ghandeharizadeh et al., mentioned above, minimizes the expected time to read an entire program from disk. In a practical context, this measure is not necessarily representative of the resources required or to be reserved in order to provide real-time guarantees to individual play-out processes. It could be used as a lower bound, but problems arise when this lower bound is attained or approached. Admission control, on-line re-negotiation, and disk scheduling algorithms tend to become more complicated as resource requirements may vary over time. This not only holds for VBR-encoded programs but also for CBR programs that cross a zone boundary. By allocating an explicit bit rate to a play-out process for its entire lifetime in order to provide real-time guarantees, as in the invention, greatly simplifies these tasks but leads to an NP-hard optimization problem. It is the heuristic approach of the current invention that provides an optimum or near-optimum solution to this problem as is further discussed below.

A disk array is considered a single disk for purposes of this invention.

The invention is relevant to HDD, as mentioned above, as well as to optical disk drives, such as CD-ROM and DVD R+W. The faster types of these optical disk drives use constant angular velocity. As a result the transfer rate is a function of the radial distance from the disk's center as it is with HDD.

### BRIEF DESCRIPTION OF THE DRAWING

The invention is explained in further detail, by way of example and with reference to the accompanying drawing wherein:

FIG. 1 gives an example of a cost function;

FIG. 2 gives an example of the iterative process to find the optimized ordering;

FIG. 3 illustrates storing multiple files on a disk in an off-line setting;

FIG. 4 is a diagram illustrating the transfer rate of an MZR disk; and

FIG. 5 illustrates storing multiple files on a disk in an on-line setting.

Throughout the figures, same reference numerals indicate similar or corresponding features.

### DETAILED EMBODIMENTS

One of the problems considered by the inventor is that of how to store multiple programs on a disk in such a way that disk resource usage is optimized. Each specific one of the programs, referred to with index “i” is assumed in this example to be characterized by its bit rate “rᵢ”, its duration “dᵢ”, its size “sᵢ” and popularity “yᵢ”. Examples of these concepts have been given above.

With a program i stored on disk a transfer rate Rᵢ can be associated that gives the minimum rate at which data from this program can be retrieved from the disk. It corresponds with the transfer rate of data of this program that is read from locations closest to the inner edge of the disk. When a number of programs are stored the transfer rate Rᵢ of program i depends on the overall allocation of storage space to the individual programs.

When a play-out program is started for program i the disk system has to allocate to this process at least a fraction of rᵢ/Rᵢ of its time available for reading for (an average of) dᵢ time units. This ratio of rᵢ/Rᵢ can be considered the momentary disk load for this process. Allocating less than this ratio may eventually lead to a buffer underflow. Assuming a worst-case scenario, a total of (rᵢ dᵢ)/Rᵢ of disk resources has to be reserved for this process. Per unit of time, a fraction of yᵢ of the requests for programs relate to program i. Accordingly, the expected amount of disk resources required for an arbitrary play-out process equals Σyᵢ (rᵢ dᵢ)/Rᵢ, the summation being over all programs on disk. For ease of exposition, the product yᵢ rᵢ dᵢ will be referred to herein as the weight “wᵢ” of program i.

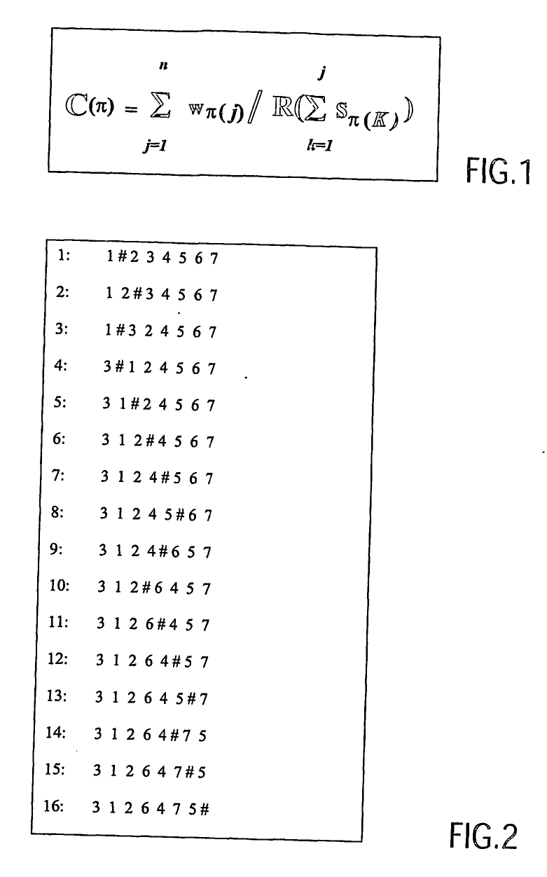

Consider a disk of size S with a transfer rate R(.) that is non-increasing in anti-radial direction. Consider a number of n programs, 1, 2, . . . , n, each program i having a non-vanishing weight value wᵢ and a non-vanishing size sᵢ so that all sizes sᵢ add up to S. The problem to be solved can then be formulated as: find an ordering “π” of these programs on disk such that the value of cost function “C(π)” as defined in FIG. 1, is a minimum. The transfer rate R(.) is sufficiently general to cover MZR disks. The ordering n lists the order wherein the programs are stored on disk: program π(1) is stored first, starting at the disk's outer edge, followed by program π(2) as close to the outer edge as allowed by stored program π(1), and so on.

The ordering of the programs that minimizes the cost function is the optimum solution discussed above. It can be shown that this optimization problem is NP-hard in the strong sense.

The inventor proposes to solve the problem as follows. First, consider storing n programs in a sequence from the outer edge to the inner edge in the order of their non-increasing weight-over-size values. This ordering is referred to as the “initial ordering”. Simulations were conducted on 1000 instances, both for a constant-density disk and for an MZR disk. For each instance a random number of programs between 5 and 10 was chosen, each program having a randomly chosen weight value in the range [0,1) and a randomly chosen size in the range [0,m) wherein m equals twice the size of the disk divided by the number of programs chosen in this instance. The simulations for the constant density disk show that in roughly 75% of the instances this initial ordering gives an optimum solution. For the remaining 25% of the instances, the cost of each solution was at most 1% off the optimal cost, 5% of the instances exceeding an offset of 0.1%. The simulations for the MZR-disk resulted in 25% of the instances being the optimal solution. For 75% of the instances the cost was within 3.5% of the optimum, in 0.5% of the instances the cost being over 2% off the optimum.

Then one may attempt to still improve the allocation of the programs to a position in the sequence in an iterative process by swapping the positions of two adjacent programs. Let π(i) indicate the program at location “i” in the ordering “π”. The iterative process then maintains an ordering X and a position “i” such that the value of the cost function cannot be improved anymore by switching any two adjacent elements in the array π(1), π(2), . . . , π(i). After initializing i to unity, it is checked if swapping elements at locations i and i+1 results in a lower cost as long as i<n. If there is a lower cost, then this swap is carried out, and i is decremented by unity if i>1. If the cost is not lower, then i is incremented by unity. This algorithm is guaranteed to finish, because each step either increments i or lowers the cost. There are a finite number of cost values, at the most n!, so the algorithm ends.

The algorithm alternates between searching in a forward direction for a first candidate, at position i+1, to move in the reverse direction, and dragging a candidate found in revere direction until the cost cannot be lowered further. This algorithm is therefore referred to herein as Search-and-Drag (SAD).

FIG. 2 illustrates the iterations in an example of SAD using seven programs.

The state at the start of each iteration step is shown. The mark “#” lies between position i and position i+1. At the second iteration, the program at original position 3, program 3 for short, is the first candidate found. Program 3 is subsequently dragged to the first position in the third iteration. Then, at iteration 8, program 6 is the next candidate found, etc.

Simulations suggest that the computational complexity of SAD is at the most O(n₂). A variation on the SAD theme is the following. Instead of starting a search after a drag at position i+1, a jump is performed first to one step beyond the position where this drag began. This Jump-Search-and-Drag algorithm (JSAD) has a worst case computational complexity of O(n²): at the most n candidates are found, and each candidate is dragged over a distance n at the most. Simulations indicate that JSAD has a similar performance as SAD. A variation on the iterative process is the following search-and-switch (SAS): go over the initial ordering once and switch any two adjacent programs if this decreases the value of the cost function.

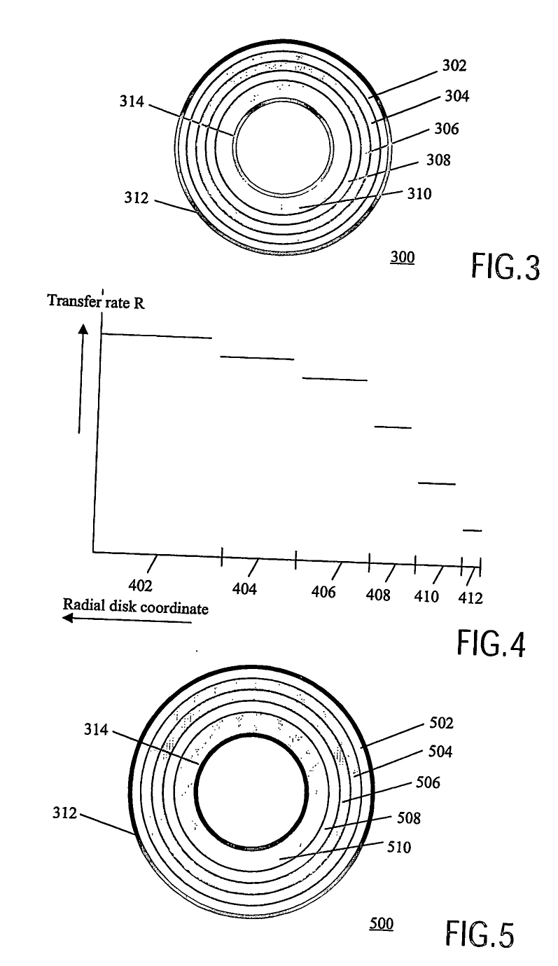

FIG. 3 illustrates schematically the storing of multiple files on a disk 300 in an off-line setting. Disk 300 stores files 302, 304, 406, 308 and 310 in this example. Disk 300 has an outer edge 312 and an inner edge 314. In a direction from outer edge 312 to inner edge 314, files 302-310 form a sequence wherein file 302 is stored close to the outer edge 312, file 304 is next, file 306 follows file 304 and precedes file 308, and file 310 is stored close to inner edge 314 and follows file 308. Each respective one of files 302-310 has a respective value of the ratio of the respective file's weight over the respective file's size as discussed above. In the invention, files 302-310 are stored so that sequence of ratio values is monotonically non-increasing from outer edge 312 to inner edge 314. The value of the ratio associated with file 302 is not smaller than the ratio associated with file 304. The value of the ratio associated with file 304 is not smaller than the ratio associated with file 306. The value of the ratio associated with file 306 is not smaller than the ratio associated with file 308. The value of the ratio associated with file 308 is not smaller than the ratio associated with file 310.

FIG. 4 is a diagram of the transfer rate of an MZR disk which is a function of the radial disk coordinate. An MZR disk is partitioned into a plurality of zones 402, 404, 406, . . . , 412. With each zone is associated a respective range of radial disk coordinates, and a respective transfer rate. Within a zone, the transfer rate is constant. Zone 402 is near the outer edge of the MZR disk and zone 412 is near the inner edge of the MZR disk. Now, consider cost function C of FIG. 1. Transfer rate R appears in the denominator of the terms of the summation. It is clear that changing locations of files within a specific zone does not affect the cost function.

FIG. 5 illustrates schematically the storing of multiple files on a disk 500 in an on-line setting. Storage space of disk 500 is segmented into multiple classes 502, 504, 506, 508 and 510. Each such class is capable of storing a plurality of files. With each class 502-510 is associated a respective value of a class parameter that is used to control storing files in an on-line setting. The class parameter values for classes 502-510 form a monotonically, e.g., non-increasing sequence from outer edge 312 to inner edge 314. The idea is to store a file in a particular one of classes 502-510 whose class parameter value forms a best match with the weight-over-size ratio of the file to be stored in order to optimize resource usage during operational use of the file. For example, the class parameter value is an average of the weight-over-size ratios of a subset of files that are assigned to that class in a hypothetical experiment conducted with a large set of files to find the optimum or a near-optimum allocation as discussed above.

1. A method of storing multiple data files on a disk, wherein:
each respective one of the data files is characterized by a respective value of a size of the respective file, and a respective value of a weight that depends on a sustainable play-out speed of the respective file, a duration of a play-out process of the respective file and on a popularity of the respective file;
the method comprises accommodating the respective data files at respective locations on the disk with respective radial disk coordinates, so that the respective files form a substantially monotonically non-increasing sequence of respective values of the ratio of the respective value of the weight over the respective value of the size in a direction of decreasing respective radial disk coordinates.

2. The method of claim 1, wherein at least one of the data files comprises video content.

3. The method of claim 2, used in a VOD service.

4. The method of claim 1, wherein the disk comprises a MZR disk.

5. The method of claim 1, wherein at least one of the data files comprises VBR-encoded content.

6. A storage system comprising a disk storing multiple data files, wherein:
each respective one of the data files is characterized by a respective value of a size of the respective file, and a respective value of a weight that depends on a sustainable play-out speed of the respective file, the duration of a play-out process of the respective file and the popularity of the respective file; and
the respective data files are stored at respective locations on the disk with respective radial disk coordinates, so that the respective files form a substantially monotonically non-increasing sequence of respective values of the ratio of the respective value of the weight over the respective value of the size in a direction of decreasing respective radial disk coordinates.

7. The system of claim 6, wherein at least one of the data files comprises video content.

8. The system of claim 6, wherein the disk comprises an MZR disk.

9. The system of claim 6 wherein at least one of the data files comprises VBR-encoded content.

10. A method of enabling to store a data file on a disk, wherein:
the data file is characterized by a value of a size of the file, and by a value of a weight that depends on a sustainable play-out speed of the file, a duration of a play-out process of the file and on a popularity of the file;
the disk is organized in a plurality of respective segments, each having a respective radial disk coordinate;
each of the respective segments is assigned a respective value of a parameter so that the respective values form a monotonic series in a direction of decreasing radial disk coordinates; and
the method comprises enabling to store the data file in a specific one of the segments whose value of the parameter best corresponds with a ratio of the value of the weight over the value of the size.

11. The method of claim 10, being used in a VOD service.

12. A storage system comprising a disk for storing a data file, wherein:
the disk is organized in a plurality of respective segments, each having a respective radial disk coordinate;
each of the respective segments is assigned a respective value of a parameter so that the respective values form a monotonic series in a direction of decreasing radial disk coordinates;
the data file is characterized by a value of a size of the file; and by a value of a weight that depends on a sustainable play-out speed of the file, a duration of a play-out process of the file and on a popularity of the file; and
the system enables to store the data file in a specific one of the segments whose value of the parameter best corresponds with a ratio of the value of the weight over the value of the size.

13. A method of storing multiple files on an MZR disk, wherein:
each respective one of the files has a respective size and a respective weight that depends on a sustainable play-out speed of the respective file, a duration of a play-out process of the respective file and on a popularity of the respective file;
each respective file has a respective value of the ratio weight-over-size; the disk comprises a plurality of respective zones;
with each respective zone is associated a respective value of a transfer rate so that the respective values of the transfer rate form a monotonically decreasing series in a direction of decreasing radial disk coordinates;
the method comprises allocating the files to the zones so that substantially each specific one of the files allocated to a particular one of the zones has a weight-over-size ratio not lower than a further weight-over-size ratio of substantially any further file allocated to a further zone whose value of the transfer rate is lower than the value of the transfer rate of the particular zone.

14. A storage system with multiple files stored on an MZR disk, wherein:
each respective one of the files has a respective size and a respective weight that depends on a sustainable play-out speed of the respective file, a duration of a play-out process of the respective file and on a popularity of the respective file;
each respective file has a respective value of the ratio weight-over-size; the disk comprises a plurality of respective zones;
with each respective zone is associated a respective value of a transfer rate so that the respective values of the transfer rate form a monotonically decreasing series in a direction of decreasing radial disk coordinates;
the files are allocated to the zones so that substantially each specific one of the files allocated to a particular one of the zones has a weight-over-size ratio not lower than a further weight-over-size ratio of substantially any further file allocated to a further zone whose value of the transfer rate is lower than the value of the transfer rate of the particular zone.
